(19) United States
(12) Patent Application Publication
(10) Pub. No.: US 2013/0249917 A1
(43) Pub. Date: Sep. 26, 2013

(54) PROFILE DATA VISUALIZATION

(71) Applicants: Michael C. Fanning, Redmond, WA (US); Cenk Ergan, Bellevue, WA (US); Andrew R. Sterland, Seattle, WA (US)

(72) Inventors: Michael C. Fanning, Redmond, WA (US); Cenk Ergan, Bellevue, WA (US); Andrew R. Sterland, Seattle, WA (US)

(73) Assignee: MICROSOFT CORPORATION, Redmond, WA (US)

(21) Appl. No.: 13/429,566

(22) Filed: Mar. 26, 2012

(51) Int. Cl. G06T 11/20

(52) U.S. Cl. 345/440

(57) ABSTRACT

Profile data is visualized in a number of ways to visually communicate program performance issues and facilitate analysis thereof. In one instance, a plurality of correlated visualizations can be presented that provide different types of views of program profile data. Further, logically grouped profile data can be presented to enable meaningful analysis of program execution. Visualizations can also reflect the state of profile data with respect to designated performance goals, and mechanisms are provided to enable recording and playback profile data, among other things.

### BACKGROUND

Profiling enables examination of program behavior to focus performance tuning. A profiler is an automated tool that produces a profile of a program from information collected during program execution. A profile captures behavioral characteristics of a program. One or more portions of program can be identified from a profile as candidates for optimization. For example, a profile might indicate that an excessive amount of time is spent executing a particular function. In other words, a profile aids understanding of program behavior to allow concentration of optimization efforts. Profilers are often classified based on their methods of gathering data, among other things.

There are two distinct types of approaches to gathering profile data, namely instrumentation and sampling. In the instrumentation approach, code is added to a program to collect information during execution. Here, the added code is an instrument that measures program behavior as the program executes. For example, the frequency and duration of function calls can be measured. In the sampling approach, an executing program is halted periodically using operating system functionality and sampled to determine the current state of execution. Accordingly, it can be noticed that twenty-percent of the time the program is executing a specific code point. The sampling approach thus provides a statistical approximation rather than exact data.

Profile data is often presented as a call tree (a.k.a., call graph) that breaks down program execution. For example, a call tree can show function execution paths that were traversed in a program. The root node of the call tree can point to the entry point into the program and each other node in the tree can identify a called function as well as performance data such as execution time of the called function. The edges between nodes can represent function calls, and cycles can be indicative of recursive calls. The call tree can be analyzed by a developer to identify program hotspots, such as functions that occupy a large portion of execution time, among other things.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to visualization of profile data. A set of one or more visualizations can be rendered to facilitate program performance analysis utilizing either real time or historical profile data. In accordance with one aspect, a plurality of correlated visualizations can be presented that provide different types of views of profile data. In accordance with another aspect, a set of visualizations can operate with respect to logically grouped profile data to enable meaningful analysis of program execution. Here, profile data can be ascribed to groups that convey information about high-level semantic function of a program or sub-systems, among other things, based on an organizational scheme, for example. Mechanisms are also provided to enable recording and playing back profile data as well as controlling the granularity or scope thereof. Further, visualizations can provide feedback based on designated performance goals.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a visualization system.

FIG. 2 is a block diagram of a representative visualization engine.

FIG. 3 is an exemplary screenshot of a set of visualizations of profile data.

FIG. 4 is an exemplary screenshot of a set of visualizations of profile data.

FIG. 5 is an exemplary screenshot of a report visualization of profile data.

FIG. 6 is an exemplary screenshot of two graph visualizations of profile data.

FIG. 7 is an exemplary screenshot of a table visualization of profile data.

FIG. 8 is an exemplary screenshot of a graph visualization of profile data.

FIG. 9 illustrates two exemplary screenshots of graph visualizations of profile data.

FIG. 10 is an exemplary screenshot of visualizations of profile data including two graphs.

FIG. 11 is an exemplary screenshot of a program user interface.

FIG. 12 is a block diagram of a program profile system.

FIG. 13 is a block diagram of a program profile system.

FIG. 14 is block diagram of a representative-data collection component.

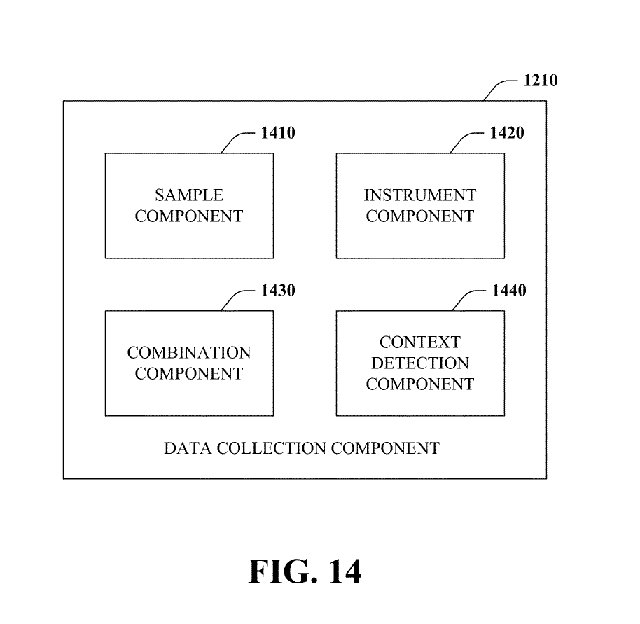

FIG. 15 illustrates data collection for start/stop event pairs.

FIG. 16 illustrates data collection for stack samples.

FIG. 17 is a flow chart diagram of a method of program profiling.

FIG. 18 is a flow chart diagram of a method of grouping profiling data.

FIG. 19 is a flow chart diagram of a method of visualizing profile data.

FIG. 20 is a schematic block diagram illustrating a suitable operating environment for aspects of the subject disclosure.

### DETAILED DESCRIPTION

Visualization of profile data conventionally suffers from several problems. First, data is expressed in a manner that is too granular and abstract. That is, data is rendered at a time scale that cannot be associated with user action and/or meaningful program execution semantics (e.g., refresh window). Navigating a complete profile session rendered as a timeline is therefore difficult or unproductive toward identifying performance issues. Second, profilers traditionally operate against historical information. By way of example, a program can be started, collection is enabled, the program is exercised, collection is halted, and the captured data is subsequently analyzed. While there are some performance tools that can provide real time application monitoring, these tools are limited as well since they cannot be started and stopped in flexible ways, various counter are not correlated with one another, and there is limited sophistication in terms of analysis and visualization provided.

Details below are generally directed toward visualization of profile data in various ways to facilitate program performance analysis. In accordance with one aspect, a plurality of correlated visualizations can be presented that provide different types of views of profile data. In accordance with one particular embodiment, at least a portion of the profile data can be logically grouped profile data to enable meaningful analysis of program execution. Here, profile data can be ascribed to groups that convey information about high-level semantic function of a program or sub-systems, among other things, based on an organizational scheme, for example. Visualizations can also reflect the state of profile data with respect to designated performance goals, and mechanisms are provided to enable recording and playback of profile data as well as controlling the scope of profile data. In one instance, the set of visualizations can be presented simultaneously with program execution. Alternatively, the set of visualization can operate over historical data.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

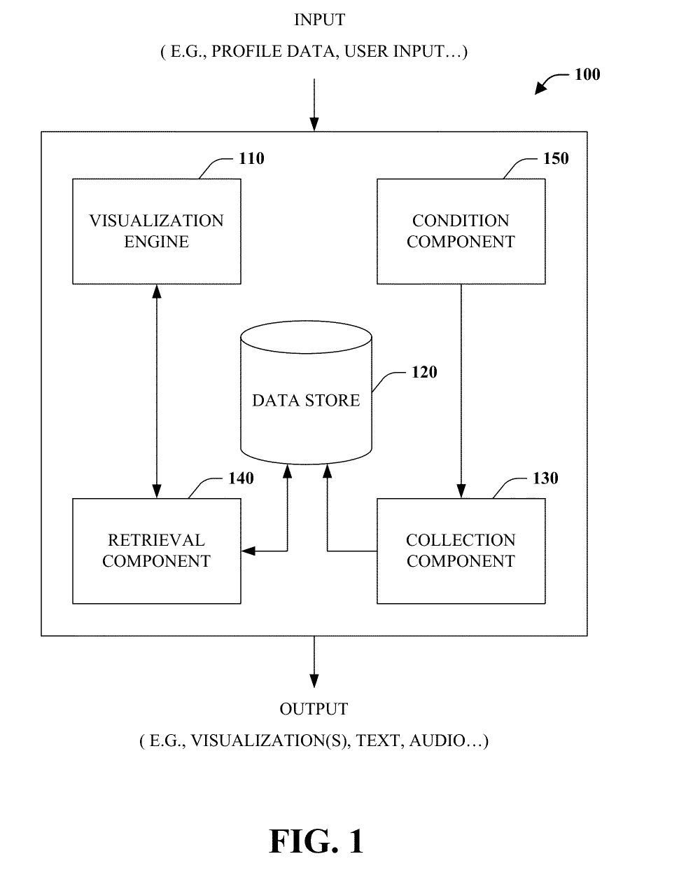

Referring initially to FIG. 1, a visualization system 100 is illustrated that facilitates program execution analysis by way of set of visualizations and user interactions therewith. The visualization system 100 can accept as input, and operate with respect to arbitrary collected and/or computed profile data (a.k.a. program-profile data). Further, the profile data can be real time data streamed live from a currently executing program or historical data supplied from a persistent log, for example. In accordance with one embodiment, the visualization system 100 is configured to receive or retrieve and operate over logically grouped profile data. As will be described further hereinafter, profile data can be ascribed to groups as a function of an organizational schema that defines groups and relationships between groups in a manner independent of execution paths. Consequently, rather than being rendered at a granular function level, profile data can displayed at a logically meaningful level. For instance, profile data can be ascribed to groups that convey information about high-level semantic function of a program or sub-systems thereof (e.g., opening a document, recalculating layout, rendering content in a window . . . ) or information external to the program itself such as project personnel, among other things. The visualization system 100 can also be configured to be responsive to user input with respect to provided visualizations or other output (e.g. text, audio . . . ). Accordingly, visualizations can be updated to focus on a particular segment of data or particular level of granularity of interest to a user, for example. Further yet, a user can designate specific visualizations be used to render data and as well as combine one or more visualizations, among other things.

The visualization system 100 includes visualization engine 110, data store 120, collection component 130, retrieval component 140, and condition component 150. The visualization engine 110 (also a component as defined herein) is configured to render a set of one or more visualizations. Herein, rendering refers to converting coded content to a format for display, or generating content in a display format, which can subsequently be presented on a physical display (e.g., LCD, touch screen . . . ) connected to a computer or other processor-based device. The visualization engine supports various types of visualizations, or visual content, including but not limited to numerous graphs (e.g., line, bar, pie . . . ), images, and textual content, among other things. Upon receipt or acquisition of input, the visualization engine 110 can render one or more visualizations populated with profile data. In accordance with one embodiment, the visualization engine 110 is configured to operate in real-time with respect to stream of profile data associated with an executing program. Alternatively, the visualization engine 110 can operate with respect to historical profile data (e.g., persisted log file). In any event, note that the visualization need not be static but rather can be animated in response to acquired profile data. In other words, visualizations can be updated as profile data is acquired.

The data store 120 is a computer readable/accessible medium that is configured to store arbitrary and potentially copious amounts of data. As examples, the data store 120 can be embodied as a log file, a database, and/or an in-memory representation of data. In an event, the data store 120 can save substantially any data to facilitate profile visualization. Furthermore, while illustrated within the visualization system 100 the data store 120 can reside outside the visualization system 100 as opposed to inside the visualization system 100 or multiple data stores can be provisioned inside and outside the visualization system 100.

The collection component 130 is configured to accumulate and record, or save, data, for instance to the data store 120. For example, the collection component 130 can save a stream of profile data and optionally user input. In accordance with one particular embodiment, the collection component 130 can acquire and save one or more screenshot images of an executing program being exercised or other visualizations. User interactions with respect to the one or more screenshot images such as mouse movements, clicks, and text entry, can be saved as well.

The retrieval component 140 is configured to retrieve data from the data store 120 and provide the data to the visualization engine 110. In accordance with one embodiment, the retrieval component 140 can simply push data to the visualization engine. Alternatively, the retrieval component 140 can provided data in a response to a parameterized request from the visualization engine 110. Further, the retrieval component 140 is configured to perform various processing (e.g., query processing) of the data acquired from the data store prior to returning processed data to the visualization engine 110 for rendering. For example, a particular subset of profile data can be returned that satisfies a request. The retrieval component 140 can also be configured to save data, for example to the data store 120. For instance, the retrieval component 140 can cache processed results to the data store 120 to provide an efficient response to requests that are parameterized in the same way. Accordingly, various caching techniques known in the art can be employed.

In one particular embodiment, the retrieval component 140 can enable playback of historical profile data. More particularly, the retrieval component 140 can be configured to enable replay to be started, stopped, paused, moved back to a previous point in time, moved forward to a later point in time, slowed down, or sped up. For instance, a user can instruct the system to move forward to a particular point in time of interest and then pause the playback to further investigate the data. Furthermore, if execution is delineated into segments movement can be made from a first segment to a second segment.

The condition component 150 is configured to enable specification of significant runtime conditions, or, in other words, performance goals. A user can specify hard and/or soft conditions such as those relating to throughput (e.g., desired frame rate) of a program utilizing functionality provided by the condition component 150. Such conditions can be saved to the data store 120 directly or by way of collection component 130, and subsequently acquired and employed by the visualization engine 110. The visualization engine 110 can present these conditions visually as a form of user feedback. As examples, event markers can be applied to timelines, a particular color can be applied to a graphic, optionally flashing, or other dynamic indicators of condition failure or satisfaction can be presented. In accordance with one embodiment, the visualization engine 110 can present readable text describing met or unmet conditions in a message window.

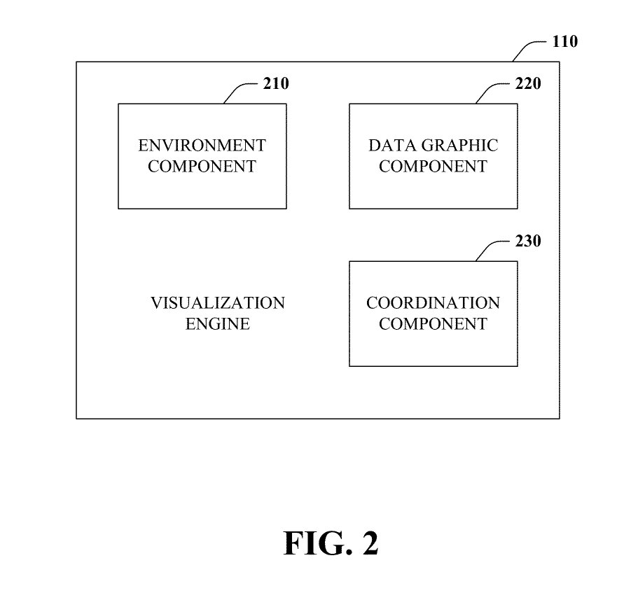

Turning to FIG. 2 a representative visualization engine 110 is depicted. The visualization engine includes three components, environment component 210, data graphic component 220, and coordination component 230. The environment component 210 is configured to generate an integrated environment for presenting a set of visualizations in a manner that enables a rich experience. Further, a single set of controls can be utilized to interact with various visualizations. In accordance with one embodiment, the environment can include functionality for selecting a set of profile data and one or more visualizations to apply to the profile data. Once presented, user can initiate a plurality of operations with respect to the data and visualization thereof. For instance, segments of profile data can be isolated and a feature can be provided to move to the next segment. Further, granularity, or scoping can be controlled to enable zoom in and zoom out features that alter the scoping profile data (e.g., milliseconds, seconds, minutes . . . ).

The data graphic component 220 is configured to generate visualizations of profile data, for example in an integrated environment. For example, the visualization can include various types of graphs such as pie, line, or bar graphs. However, any visual mechanism for that presents data in a useful manner can be employed. By way of example, and not limitation, one or more screenshot images of an executing program can be provided by the data graphic component 220.

The coordination component 230 is configured to coordinate, or correlated data across visualizations of profile data. In accordance with one aspect, numerous visualizations can be rendered simultaneously to facilitate analysis of program execution. The coordination component 230 enables the visualization to be coordinated in some manner, for example based on time (e.g. timeline). In this manner, all visualizations will render the profile data in concert. By way of example, if a user initiates zooming in on a particular segment of data in one visualization (e.g., line graph), other active visualizations (e.g., bar graph, pie graph . . . ) can be updated to reflect the same segment of data in a given period of time.

What follows is a series of exemplary screenshots to aid clarity and understanding with respect to functionality enabled by the visualization system 100. The screenshots are only one possible arrangement of graphical elements. Other types of graphics and arrangements thereof are possible. Accordingly, the screenshots are not intended to limit the scope of the appended claims but rather to provide possible representations to facilitate further description and understanding of the functionality afforded by the visualization system 100. Further, although the screenshots pertain to profiling with respect to a web browsers and web applications executing within the web browser, the claimed subject matter is not limited thereto. Additionally, although discussion focuses on visualizations, other mechanisms can also be utilized, such as audio, to further enrich a user's experience in analyzing profile data.

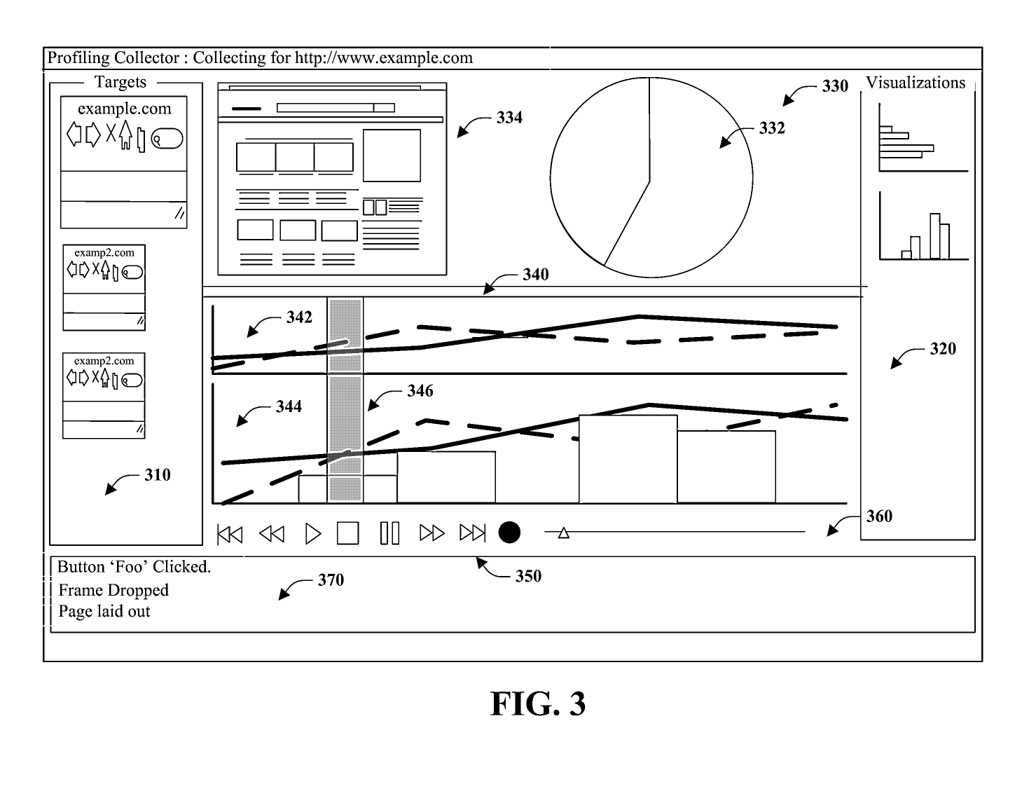

FIG. 3 illustrates a screenshot of set of visualizations that can be rendered and displayed to facilitate program execution analysis. More particularly, a plurality of correlated visualizations is utilized to present different types of views of profile data to facilitate program analysis. For example, a number of different graphs (e.g., line, bar, pie . . . ), images (e.g., screenshots of running program), and text can be utilized as detailed below. Further, such visualizations can be presented in an integrated profile environment with a set of common controls, among other things.

Area 310 is designated for target control. In other words, a particular subset or superset of profile data can be selected for display by way of a selection signal (e.g., drag and drop, click, voice command . . . ). Here, three web browser processes are displayed as thumbnails, which are selectable. The larger size of the first web browser thumbnail relative to the others indicates that it was selected and thus profile data corresponds to that particular process. Besides being a utility for collecting real time information with respect to executing programs, this target control can be used to navigate/select from persisted logs. Additionally, target control is not limited to processes/other targets that are running on a local machine. Remote instances or web applications running on attached devices can also be rendered in area 310.

Area 320 illustrates a pool of available visualizations that can be deployed against profiling data. In accordance with one embodiment, visualizations can be dragged from area 320 into another area in order to render that visualization against current profiling data. In other words, a visualization can be applied based on a selection signal (e.g., drag and drop, click, voice command . . . ) identifying the visualization. As will be described further hereinafter, it is possible to organize and overlay visualization in many ways.

Area 330 is the holder area for visualizations that comprise non-timeline based visualizations of profile data. That is, the visualizations include rendering that is not overtly associated with a timeline. Here, pie chart 332 shows a percentage breakdown of time spent between several sub-systems during the last frame rendering of an application. By way of example, the pie chart 332 can denote central processing unit utilization for an executing web application running in a browser in which the white portion indicates idle time and the black portion indicates actual processor utilization. Further, a time correlated screenshot image 334 is displayed to the left of the pie chart 332. The screenshot image 334 is a view of a target web application at a specific point in time. This view is useful in order to understand the state of the webpage and/or most recent user action associated with a specific sequence of profiling data. Note that this visualization could itself be overlaid onto the thumbnail images in target area 310. As well in some embodiments such as real time collection scenarios, this thumbnail could serve as an event surrogate for the target process. That is, the thumbnail could serve as a sink for events/other messages, which are subsequently forwarded to the actual target application. For example, user input, such as mouse moves, clicks, and text entry, can be overlaid on the screenshot image 334.

Area 340 shows a holder area for time-line-based visualizations. This area can include an arbitrary number of “swim lanes” that permit side-by-side display. Here, two visualization are illustrated namely line graph 342 and line and bar graph 344. The line and bar graph 344 illustrates the ability to overlay visualizations on top of each other. Further, the line graph 342 and line and bar graph 344 depict rendering of visualizations according to a common notion of scope or selected time, among other things. Other visualizations such as the pie chart 332 and the screenshot image 334 can also synchronize their renderings to such scope or selected time. A user can select (via a selection signal) a contiguous sequence of time that is of interest with respect to visualizations in area 340. In this case, region 346 has been selected. During or after this selection process, other visualizations can be updated according to the profile data that is selected. For example, visualizations in area 330 can alter their appearance in response to the selection.

A set of controls 350 are shown that facilitate recording and playback of data. In addition to features such as start recording, pause playback, and jump to next, among others, functionality can be implementation specific. Jump to next, for example, can be associated with several meaningful sequence points such as the next document object model (DOM) event, the next code generated sequence point, the next rendered frame, or the next failed diagnostic message, among others. Slider 360 is a control that allows control of speed of playback. In other embodiments, a similar slider can be used to control zoom in and zoom out of profiling data and/or control of the size of a recording buffer for profiling data (e.g., record last twenty-five seconds of profiling data).

Area 370 is s a message display area for rendering analysis/results that are best displayed in a scrollable form such as a list of diagnostic messages and/or a diagnostic synopsis of profile data by function name, among others. These entries can be synchronized with selection of other visualization and can themselves by used as a selection mechanisms. For instance, if a user selects a time sequence on a timeline, the diagnostic messages displayed in area 370 can be constrained to the selected timeframe. Conversely, a user might double-click a diagnostic message displayed in area 370 in which case the selection can be updated to the point in time at which that error was raised. All other visualizations could be updated to correspond to that point in time as well.

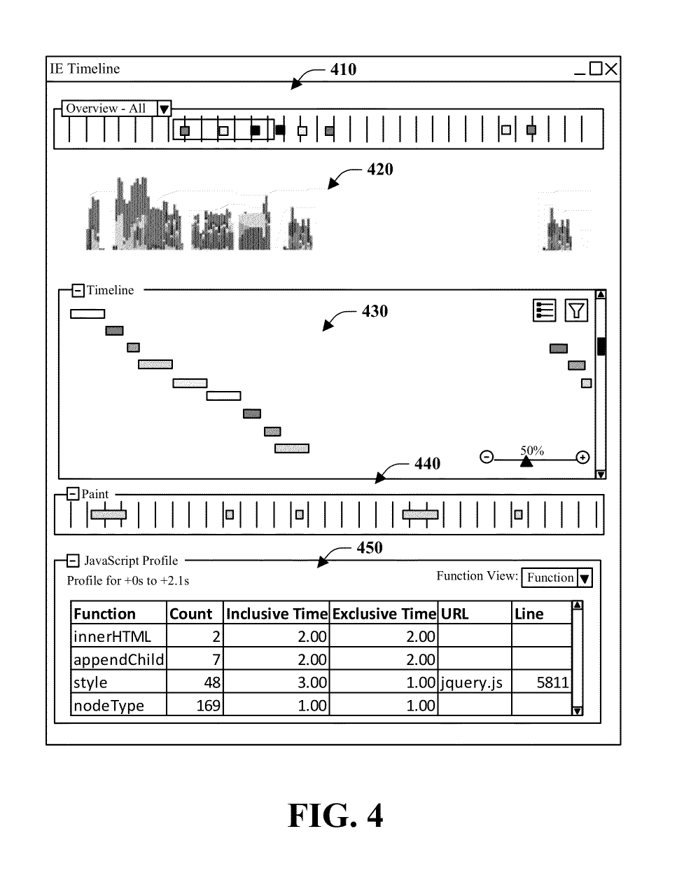

FIG. 4 illustrates a screenshot of some additional timeline visualizations. Visualization 410 illustrates navigational assistance by way of an end-to-end timeline control that shows a complete range of profile data. For example, it could represent the entire contents of a collected log, or the current buffer of data collected in real time. This master view of data can be limited to this particular control/visualization. In this embodiment, the remaining visualizations can updated their contents based on a selected window as might be indicated with respect to the complete range of profile data. Further, this timeline view can be annotated with events of particular interest. Here, the dropdown menu at the top left of the visualization can be used to select which events are marked on the timeline. For example, perhaps not all diagnostic messages should be displayed but all document object model events should. Annotations can take many forms. Here, they correspond to squares filled in different manners. In one instance, a legend can be displayed, for example as a tooltip, to clarify annotations. By way of example, differently filled squares can be utilized to distinguish amongst page events (e.g., DOM content loaded), user events (e.g., mouse clicks) and trace markers.

Visualization 420 shows a central processing unit utilization visualization generated by logical grouping. This view might make it immediately apparent, for example, that an inordinate period of time is spent rending for a specific user-interface update frame.

Visualization 430 shows a nested view of execution. Here, a hierarchy of logical sub-systems is displayed. A general request to re-render a page, for instance, might result in a series of nested execution, for example to process CSS rules, to layout elements in a page, or to render each constituent element.

Visualization 440 distills a semantic operation, into an easy-to-understand visualization that that is correlated to other selection controls/visualizations. Here, time spent rendering, or painting, a page is shown such that the period and length of time of such an operation noted by the position and size of polygons with respect to a timeline.

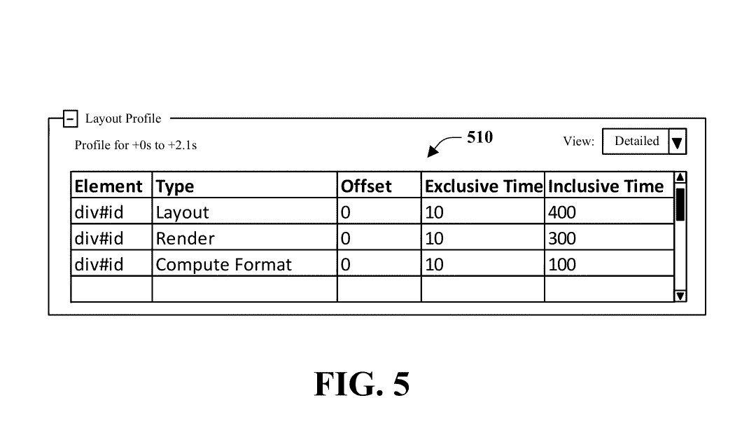

Visualization 450 presents information that is best understood as text, content render as a scrollable list, or other form, but which remains correlated to other views/profile range selectors. In this case, visualization 450 is a profile report (e.g., a call count and report of time spent executing various functions) presented for the current range of profile data. FIG. 5 illustrates another possible report visualization 510 that breaks down cascading style sheet (CSS) profile data for a specific segment of time/profile data. The level of detail for both reports can be adjusted, for example by way of a dropdown menu.

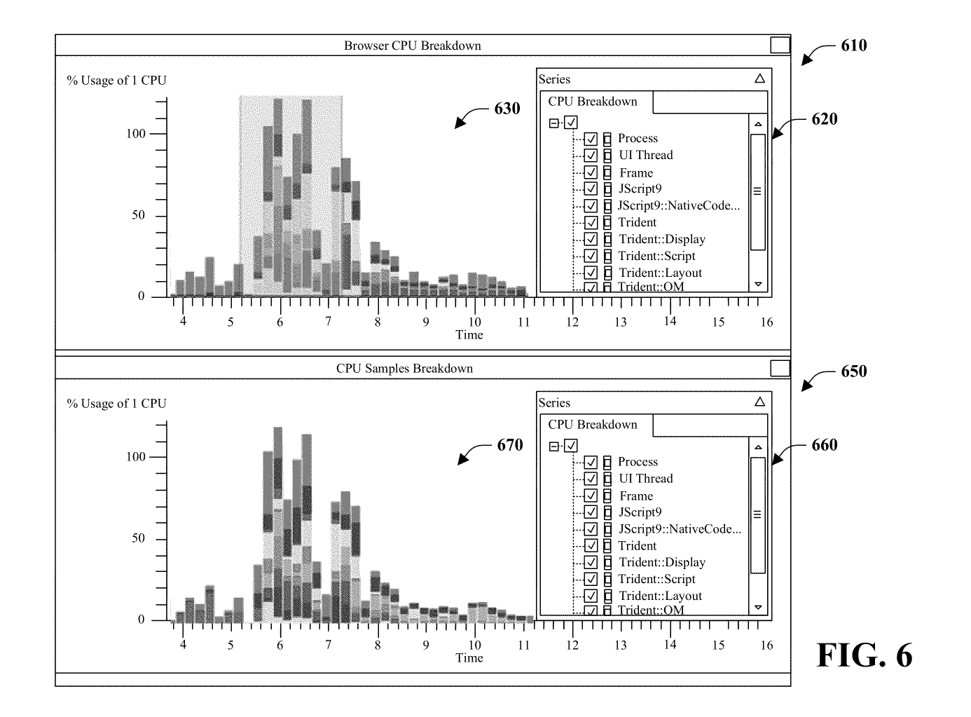

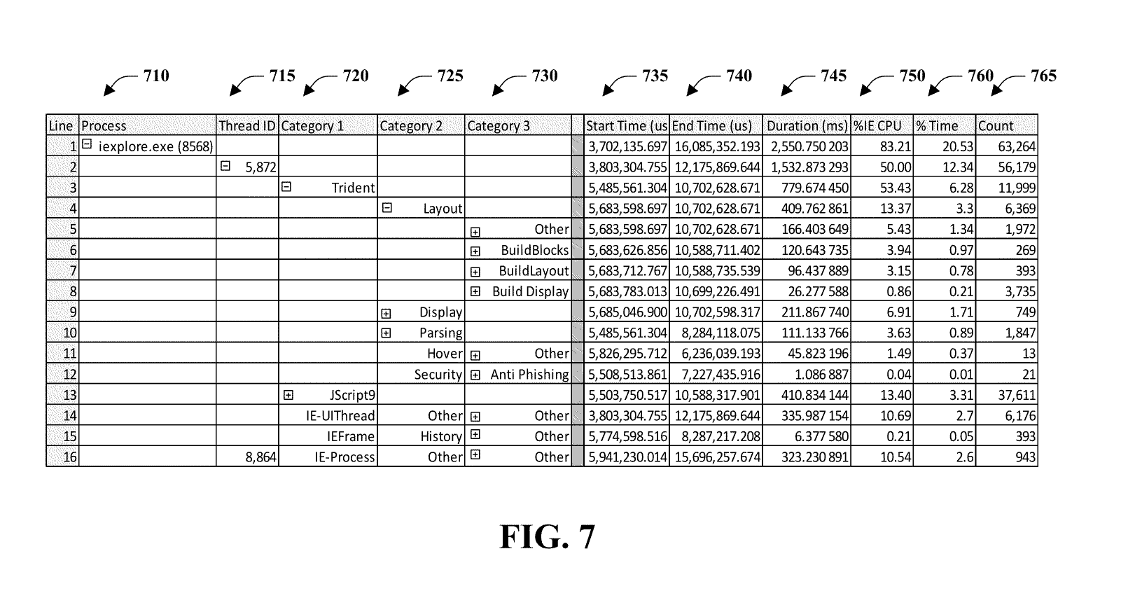

FIGS. 6 and 7 are exemplary screenshots of visualization of profile data associated with a web browser. Further, the visualization can be produced as a function of an organizational scheme such as the one provided in APPENDIX A and as will be described herein. In this instance, the organizational scheme is encoded as an XML document in which tags identify groups and the structure defines hierarchical relationships between groups. Grouping based on an organizational scheme will be described in later sections.

FIG. 6 is an exemplary screenshot showing CPU utilization breakdown of execution by subsystem, as defined by the organizational scheme specified in Appendix A. Two views, 610 and 650, are shown to enable comparison of two collection mechanisms instrumentation (e.g., start/stop pairs) and sampling (e.g., stack samples. Each of view 610 and view 650 include respective bar graphs 630 and 670 plotting percentage usage of a single central processing unit over time. Further, each graph distinguishes groups, which selectable by way of checkboxes in windows 620 and 660.

FIG. 7 is an exemplary screenshot of a table visualization of profile data. More specifically, the screenshot depicts a detailed central processor unit (CPU) utilization breakdown by subsystem as defined by an organizational scheme. The table specifies groups and subgroups with respect to a plurality of rows and columns. Column 710, labeled “Process,” specifies the root of a hierarchy of groups corresponding to the single binary or executable. Column 715 provides a grouping by thread identifiers. For each thread identifier there are three levels of sub-groups as denoted by columns 720, 725, and 730. For instance, column 720 identifies a browser-rendering engine, named “Trident,” which is broken down into “Layout,” and “Display,” among other things noted in column 725. Further, “Layout,” in column 725, is further broken down into “BuildBlocks” and “BuildLayout” groups, among others noted in column 730. Profile data is noted and aggregated for each group and sub-group and is provided in columns 735, 740, 745, 750, 760, and 765 corresponding respectively to start time, end time, duration, percentage of CPU utilization, percentage of time and count. From this table, high-level meaningful information is communicated. From a quick glance, a user can determine that the browser is spending too much time in layout and thus optimization efforts can focus on portions of the program dealing with the layout.

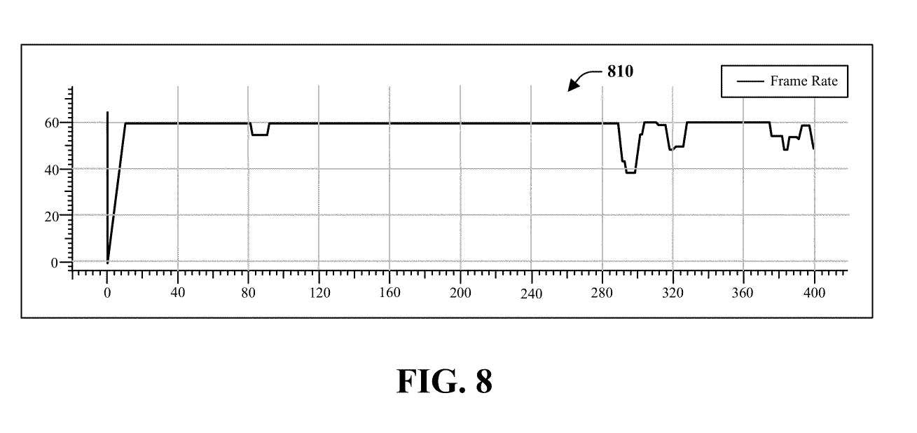

FIG. 8 illustrates visualization 810 of frame rate over time. This visualization can provide immediate feedback on the frame rate achieved per second for an application under test (or for profile data persisted to a log). Visualization 810 could represent all collected data, be rendered against a buffer or window of data of a specific size, or be restricted to a specific sequence as indicated by the current pause or selection state, as prompted by a user. Although not shown here, it can be appreciated that this visualization could be overlaid with other useful information (such as markers that indicate points of interest such as ‘navigated to new page’ or ‘frame rate dropped below acceptable threshold’). Visualization 810 among other visualizations could be correlated with the broader system, which includes the possibility of this visualization itself serving as a selection control. For example, a user might click a region of the chart, for example, where frame rate drops below some acceptable threshold, in which case, other visualizations could update their view to reflect that point in time. The CPU utilization visualization of FIG. 6 could, for example make it clear on doing so that the frame rate was compromised due to spending an inordinate period of time in processing CSS rules in advance of laying out the page.

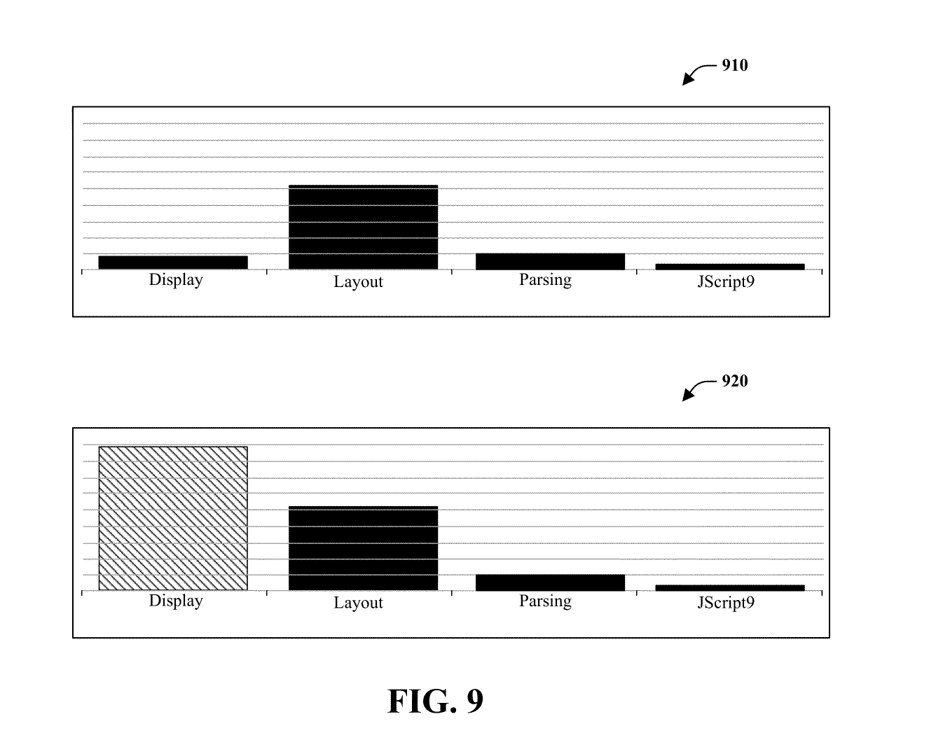

FIG. 9 shows two visualizations, 910 and 920, that provide a kind of “equalizer” view of time-spent-in-subsystem. In these visualizations, several bars are displayed that themselves represent time spent within a sub-system such as display, layout, parsing, and JavaScript (e.g., executing code). Additional bars could also be added, for example to distinguish between developer-authored JavaScript and that associated with accessing a browsers object model, for instance. Such a view provides an easily understood summary of execution and is analogous to an audio equalizer where different frequencies correspond to different sub-systems. The visualizations can be animated and synchronized to a current selection. It should be appreciated that the animation could alter/update its display according to speed of playback, or how the current timeline selection is updated, among other things.

Visualization 920 elaborates on visualization 910 by demonstrating an alteration in visual appearance (e.g., diagonal hatching, change in color, flashing . . . ) to indicate that some diagnostic standard, or performance goal, has not been met. For example, perhaps the frame rate has fallen below an acceptable threshold due to an inordinate period of time being spent in the display subsystem. In this way, the visualization provides a useful ad hoc diagnostic mechanism for users collecting information in real time or playing back a collected log. A user following up on a report of poor web page performance, for example, might connect this visualization to a running instance of the page and begin to interact with it. On making a gesture, such as hovering over a specific element of a program that compromises frame rate throughput, the visualization can provide clear feedback that performance is compromised.

Note also that a visualization can be used to annotate a general event stream with events or notifications. That is, a visualization is not only a source of interesting animations/other user interface data, but a visualization itself could be responsible for processing/analyzing profiling data in order to provide diagnostics information, or a summary of operation, among other things. A broader system includes a general mechanism for folding per-visualization events/other data into the general event stream, global timeline controllers, common error reporting areas, etc. Data associated with a specific visualization can be identifiable. This permits, for example, a user to “drag off” a specific visualization, with the result that all its events, diagnostics messages, and other artifacts associated with it would also go away.

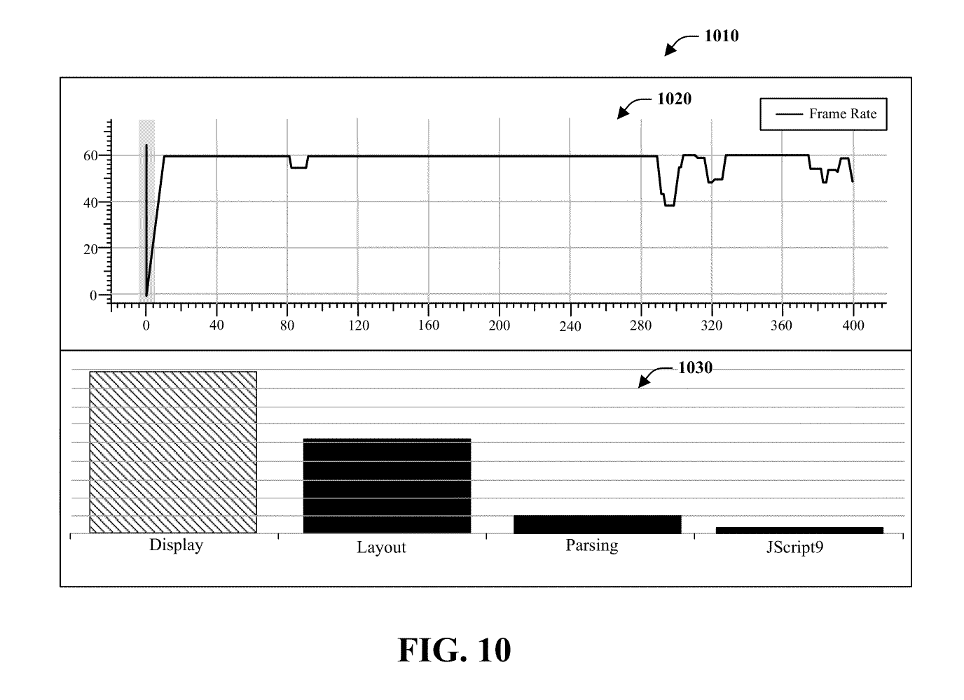

FIG. 10 provides a similar example to that of FIG. 8 in that the visualization 1010 includes a graph of frame rate over time 1020. Here, however, a time sequence in which a frame is dropped is selected. The visualization 1010 also includes a time-in-subsystem view 1030 that restricts its animation to this subset of profiling data. Consequently, it is clearly revealed that too much time is spent in the display subsystem.

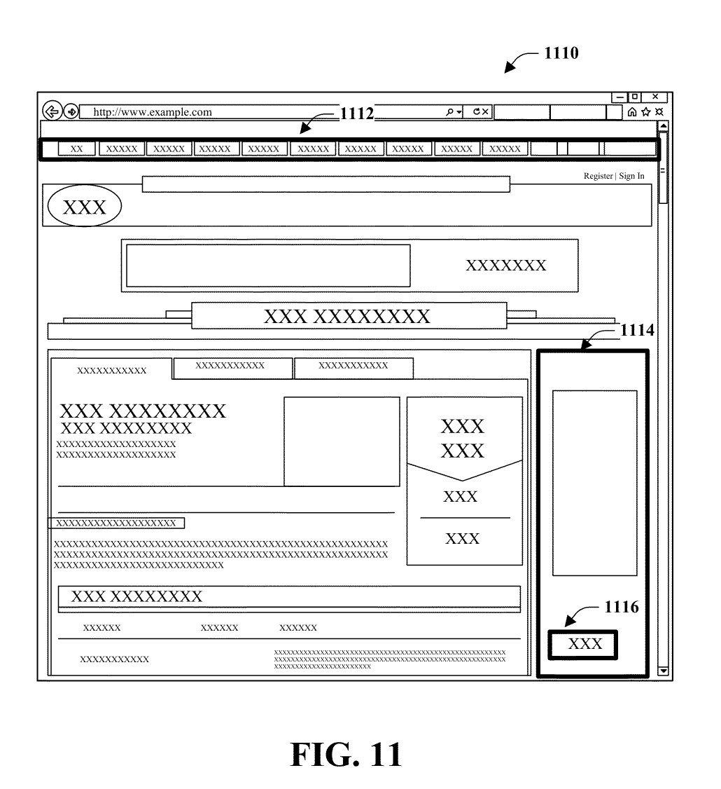

FIG. 11 demonstrates another valuable diagnostic visualization 1110 rendered as an animation. In this example, the rendering platform has been instrumented to raise events that describe regions that have been invalidated and are therefore repainted. This data, outlines on the page in some color for example, is overlaid against a screen capture of the page. This makes it immediately apparent how the page is repainting, which can be significant in diagnosing a frame rate issue, for instance. Here, there are three regions highlighted namely, region 1112, region 1114, and region 1116. This animated view can be rendered in real time, or replayed at various speeds, in response to current timeline selection, for example. This particular visualization can be useful in that it can make some kinds of processing apparent that are otherwise transparent to users. For example, a poorly constructed page might contain CSS rules/JavaScript that persistently causes a cycle of invalidated elements on the page (resulting in constant invalidation/re-rendering of the page, even in the complete absence of user input). This particular visualization could also be useful applied to the layout phase of page render in which the size and location of all page elements is calculated. Furthermore, although not shown it should be noted that user action can be captured and overlaid or simulated to aid understanding user actions such as mouse movements, clicked regions, or inputted text, among other things. Still further yet, noted that the visualization 1110 itself need not be a static image but can also be animated so as to shown a graphical user interface as it is presented during execution.

Further, although not illustrated the visualization system 100 can support a differencing mechanism. By way of example, consider two log files including historical data. Here, two screen images can be presented corresponding to the two log files with correlated profile data. Further, the profile data can be marked with identical event markers (e.g., identify a page startup, identify set of common user interface operations . . . ) to facilitate comparison.

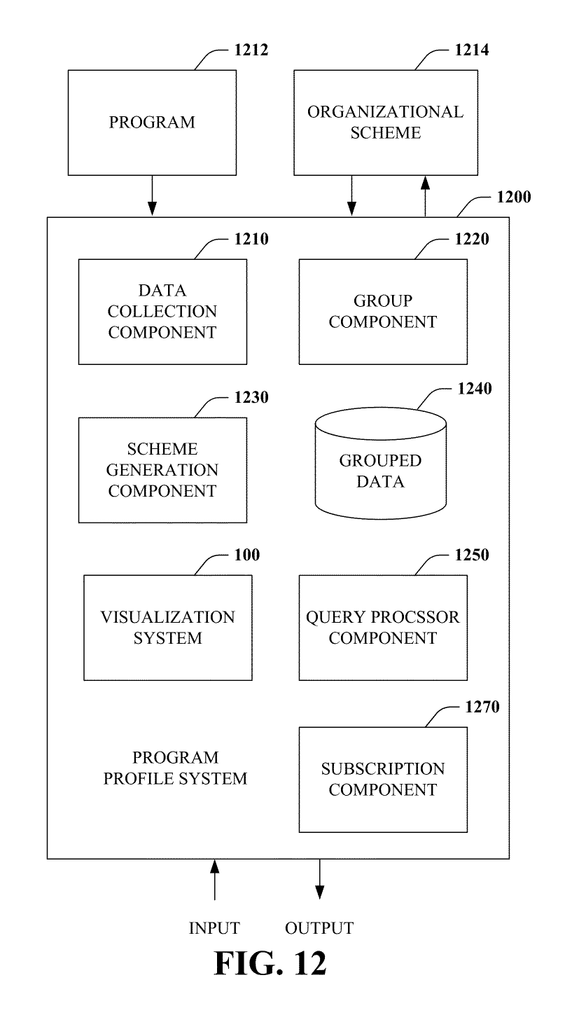

Turning attention to FIG. 12, a program profile system 1200 is illustrated. Among other things, the program profile system 1200 enables a top-down view of program performance based on a high-level understanding of the semantic purpose of code and/or its identity within a broader system (e.g., owned by program, subsystem of program, subsystem within dependent component . . . ), among other things. This can be accomplished by processing and analyzing profile data gathered by data collection component 1210.

The data collection component 1210 is configured to acquire profile data regarding program 1212. Profile data can be any arbitrary collected and/or computed data associated with execution of a program. In one instance, such profile data can correspond to a time to execute with respect to a particular function/operation. In another instance, the profile data can correspond to non-time-to execute data including occurrence or frequency of one or more events and optionally a payload associated with the occurrence of one or more events, where an event is a signal that an executing program has hit a specific point in code and a payload is data associated with hitting the specific point in code. By way of example, non-time-to-execute profile data can include bytes or objects allocated, page refreshes, registry reads/writes, worker threads spawned, or associated binary, among other things. The program (a.k.a. computer program) 1212 comprises a set of instructions specified in a computer programming language that when executed by a processor performs actions prescribed by the set of instructions. The data collection component 1210 can gather profile data from an executing program utilizing a variety of techniques including instrumentation and sampling. Work performed by the program 1212 can by captured by event/execution probes (e.g., event tracing events or callbacks from instrumented code) or stack samples collected by an operating system, for example. Data can be collected that enables analysis in terms of time-to-execute (e.g., central processing unit utilization or literal cycles spent in active execution), heap allocations, or other arbitrary information that can be expressed in custom payloads of generated events.

A combination of instrumentation and sampling can be utilized by the data collection component 1210. Data collected by each approach can augment the other approach. For example, data can be combined/merged, averaged, crosschecked, and/or statistically normalized, among other things. In this manner, advantages of both approaches can be exploited and disadvantages can be offset. As an example, both approaches can result in an observer effect, which means the act of observing a program itself can influence the program. Sampling typically does not result in a significant observer effect, but results in less precise data than that gathered by instrumentation. Accordingly, sampling data can be supplemented with instrumentation data, where appropriate. Additional mitigation against the observer effect can also be provided by creating profiling buckets that overtly group (and therefore exclude from other data) profiling data associated with operating system code that executes during production of events from instrumented code and stacks from code sampling. Further, a lightweight instrumentation approach can also be enabled where a stack is received with respect to instrumented probes/events. Suppose a single event is enabled solely for bytes allocated (which results in very little observer effect). If the “bytes allocated” event is associated with a stack, the bytes allocated data can be grouped according to stack-specified bucketing. Note, in this example, there is no sampling literally enabled. Hence, run-time events and/or collected stacks can be utilized to organize profile data.

Group component 1220 is configured to ascribe profile data gathered utilizing the data collection component 1210 to specific groups, or buckets, as a function of organizational scheme 1214. In other words, profile data can be correlated and associated based on a descriptive mechanism that defines groups and relationships between groups. In one instance, groups can convey information about high-level functions of a program or sub-systems thereof (e.g., opening a document, recalculating layout, rendering a window . . . ). In furtherance of the foregoing, the group component 1220 can be configured to initialize data structures based on a given organizational scheme 1214 and populate groups with profile data. Other implementations are also possible including, but not limited to, tagging profiling data with group information. In any event, the result of processing performed by the group component 1220 is grouped data, which can be housed in a local or remotely accessible data store 1240.

The organizational scheme 1214 can define groupings in terms of function names (e.g., full function name within a binary file (e.g., executable)), for example. Groups can be expressed in hierarchical relationship of parents and children. However, groups can be constructed that are mutually exclusive of one another, for example by defining them as sibling nodes. Groups can include sub-groups, also called or categories, as child nodes, for example. Note, however, that unless otherwise explicitly noted, use of the term “group” or “groups” is intended to include sub-groups, or categories. Functions can be associated with groups at any level and can appear in an arbitrary number of groups. In other words, functions are not limited to being ascribed to a single group but instead can appear multiple groups at any level of granularity. As well, function information can be used to aggregate data, for example based on stack samples and/or an instrumented/event-based collection. For example, a binary file name and the function name can be utilized as bases for grouping. This can be helpful with respect to distinguishing functions that span multiple binary files. Groups can also define events that do not explicitly provide binary/function details, but that provide an event identifier, which is available in the collected data. Binary/function information in this case can be implied by the set of code locations that raise a specified event. In at least some operating systems, a stack will be available on generating an event to distinguish amongst multiple code locations raising the event. Further, note that a group hierarchy as provided herein can be independent of function execution paths. The reason for this is twofold. First, in the instrumented case, a notion of a stack can be employed for grouping data that is entirely decoupled from the actual execution stack. Second, in the sampling case, arbitrary unique stacks can be associated with the same group.

Priorities can also be designated for individual groups to assist in grouping data. More specifically, priority enables breaking of a default rule of organization based on the most current stack frame (e.g., literal code stack, virtual event start/stop pair stack). Such a priority value can be expressed relative to all other groups and used to assist in grouping/bucketing decisions. If data is under consideration for a group that has a lower specified priority than other candidate groups that exist to hold the data, the data can be attributed to an alternate group that has the highest explicit or implied priority. Groups defined in hierarchical relationships can have an implicit priority based on that hierarchy. If a parent “A” includes a child “B,” for example, “B” is regarded as a higher priority group over “A.” Accordingly, data collected with a stack “A::B” will therefore be associated with group “B.” However, if group “B” is explicitly specified at a lower priority than group “A,” then data will be grouped in group “A.”

Profile data can be correlated in various ways to permit flexible querying at various scopes, among other things. As examples, profiling data might extend across process boundaries or across machines. In one instance, profile data can be grouped by time in accordance with timestamps. At a more granular level, the profile data can be grouped by central processing units or threads. Further, a universal activity identifier could be used to track inter-thread communication in useful ways, for instance by tracking activity associated with a multi-threaded transaction.

In one instance, the organizational scheme 1214 can be embodied as a data file that can be authored, edited, and maintained out-of-band from, or independent of, other processes. Further, the organizational scheme 1214 can be easily passed around. This can allow code experts to capture a useful model of analyzing profile data for a program of which they are an expert and distribute this model to non-expert users. For example, an expert in the inner workings of a web browser could generate an organizational scheme and distribute the scheme to web application developers to aid performance tuning.

In one particular implementation, the organizational scheme 1214 can be expressed in XML (eXtensible Markup Language) thus providing general readability. In this implementation, and as employed with further description below, groups or subgroups are referred to as tags or tagsets, where a tag denotes a group and a tagset refers to set of groups. Examples of organizational schemes specified in XML are provided later herein.

Scheme generation component 1230 is configured to facilitate generation of the organizational scheme 1214. In one instance, a human user can manually author the organizational scheme 1214 optionally employing pattern matching or other filtering mechanisms (e.g., regular expressions, use of wild-card characters . . . ) to aid specification. The scheme generation component 1230 can enable automatic or semi-automatic (e.g., with user assistance) generation of groups, for instance based on available information including context information. By way of example, and not limitation, source control history, which stores information regarding changes made to a program, can be mined by the scheme generation component 1230 and used to automatically generate groups. For instance, a “code owner” group could be created to enable profile data to be broken down by team or individual owner of code. This allows users to identify experts who could assist with a performance problem easily.

Query processor component 1250 is configured to enable execution of queries over grouped data. Given a query, the query processor component 1250, utilizing known or novel mechanisms, can extract and return results that satisfy the query from the data store 1240. A visualization, or diagnostic tool, for example, can employ the query processor component 1250 to acquire data.

The visualization system 100 is configured to enable grouped profile data to be visualized. The profile data can be rendered in an arbitrary number of ways rather than being limited to conventional call trees. Further, since profile data is grouped at a logically meaningful level, visualizations can exploit groupings and further aid a human user in understanding profile data. In accordance with one embodiment, the visualization system 100 can spawn a graphical user interface that graphically depicts grouped profile data and enables interaction with the data. For example, a query can be authored over the grouped data by the visualization system 100, or a human user, and filtered results returned as a function of the query. Further, a mechanism can be provided to allow users to drill down to acquire more detailed data as well as rollup to view data at a more abstract/high-level.

While the program profile system 1200 includes the visualization system 100, it should be appreciated that visualization or diagnostic tools can be external to the program profile system 1200. In this scenario, interaction can be accomplished in a similar manner, for example by querying the profile system for requisite data. Additionally or alternatively, the program profile system 1200 can push profile data to the visualization system 100 as events where the visualization system is a subscriber to such an event stream. Furthermore, note that the visualization system 100 can be extendable in various ways. For example, initially the visualization system 100 can support a first set of visualizations. Subsequently, a second set of visualizations can be added by way of a third-party plugin or through an update/upgrade to the program profile system 1200, for instance.

Subscription component 1270 provides an additional or alternate manner of disseminating grouped data. More specifically, grouped data housed in data store 1240 can be delivered in accordance with a publish/subscribe model. The subscription component 1270 can offer and manage subscriptions and publish the grouped data to interested subscribers.

The program profile system 1200 is not limited to operating with respect to real-time execution of a program, or, stated differently, as profile data is collected. Additionally, the program profile system 1200 can operate with respect to historical data, or at a time post-collection. For example, an arbitrary organizational scheme can be overlaid on a persisted log to enable data to be viewed at a meaningful level in terms of program function and structure. In other words, an arbitrary number of views can be raised against trace data by applying alternate groupings.

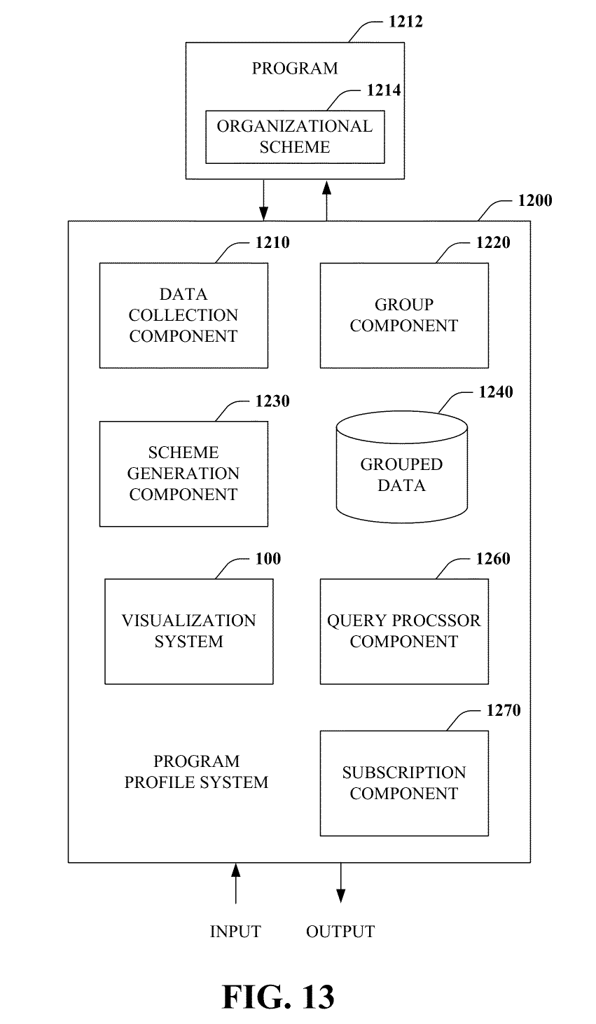

As shown in FIG. 12, the organizational scheme 1214 can be external to not only the program profile system 1200 but also the program 1212. This has many benefits including, among others, portability and allowing the organizational scheme to be changed easily. However, the disclosed subject matter is not limited thereto. In an alternate embodiment, the organizational scheme 1214 can be embedded with the program 1212, or a version thereof, as shown in FIG. 13. For example, the organizational scheme can be encoded in such a manner that the information is provided with profile data such as part of an instrumentation event. More specifically, the organizational scheme can be encoded in program function names. Additionally or alternatively, a string identifier indicative of a group or sub-group can be associated with a function or other portion of a program and raised with an event.

Still further yet, rather than encoding the organizational scheme 1214 in the program 1212, a process for generating the organizational scheme 1214 can be encoded in the program 1212. The scheme generation component 1230 can then automatically generate the organizational scheme 1214 based on the encoded process, for instance at runtime. As an example, at runtime, an arbitrary grouping can be created by binary name, such that all profile data collected during execution of a first binary is ascribed to the first binary and all profile data collected when a second binary is executed is ascribed to the second binary. Additionally, the scheme generation component 1230 can be configured to automatically update the organizational scheme 1214 in real-time, for example as data is being collected or as part of dynamically regenerating a new view on a collected log.

FIG. 13 depicts a representative data-collection component 1210. As previously described, the data collection component 1210 is configured to acquire profiling data from a program that can subsequently be grouped as a function of an organizational scheme. The data collection component 1210 includes a sample component 1410 and an instrument component 1420. The sample component 1410 is configured to initiate sampling of a program during execution, for example by making appropriate calls to an operating system and acquiring the results. In one instance, a sample is a stack that is collected at a specific moment in time (either as a result of a specific code operation, such as an allocation event, or as part of an organized collection processes from which a general picture of code execution will be created). The instrument component 1420 is configured to receive, retrieve or otherwise obtain or acquire data resulting from program instrumentation. Here, data can be probe data effectively a start/stop pair of events, for example. In one instance, start/stop events are employed to acquire a payload. In other instances, the start stop events can be utilized to demarcate an interesting boundary (no explicit payload). A time stamp and call stack can be acquired for any generated event. Accordingly, an event can be said to implicitly carry those payloads as well. A sample can be thought of as the system forcing a “code is executing” event with a time stamp and current call stack payload. Further, note that events can be marked with an activity identifier that can flow across various contexts, such as threads, into other events. This data can be used, therefore, to correlate profile data in a flexible manner.

Combination component 1430 is configured to enable use of both instrumentation and sampling in various manners. For instance, data collected by each approach can augment the other approach. More specifically, data can be combined, utilized to cross check results, and/or statistically normalized, among other things. In this manner, advantages of both approached can be exploited and disadvantages can be mitigated. By way of example and not limitation, inherently less precise sample data can be supplemented with more precise instrumentation data.

Context detection component 1440 is configured to detect a context switch or in other words, a change in processing context. For example, a context switch can occur with regard to multiple processes sharing a CPU. In such a multitasking environment, a process can be halted and the state of a CPU stored such that the process can be resumed from the same point at a later time. Stated differently, one process is switched out of a central processing unit so that another process can run. Once a context switch is detected with respect to a program being profiled, data collection can be suspended until processing resumes or collected data can be marked such that the program profile system 1200 can differentiate data associated with a program from data that is not. In this manner, data can be excluded. For example, duration of function calls, of time-to-execute, can exclude time spent executing processes unrelated to a program being profiled, or in other words periods of inactivity with respect to a program being profiled due to a context switch.

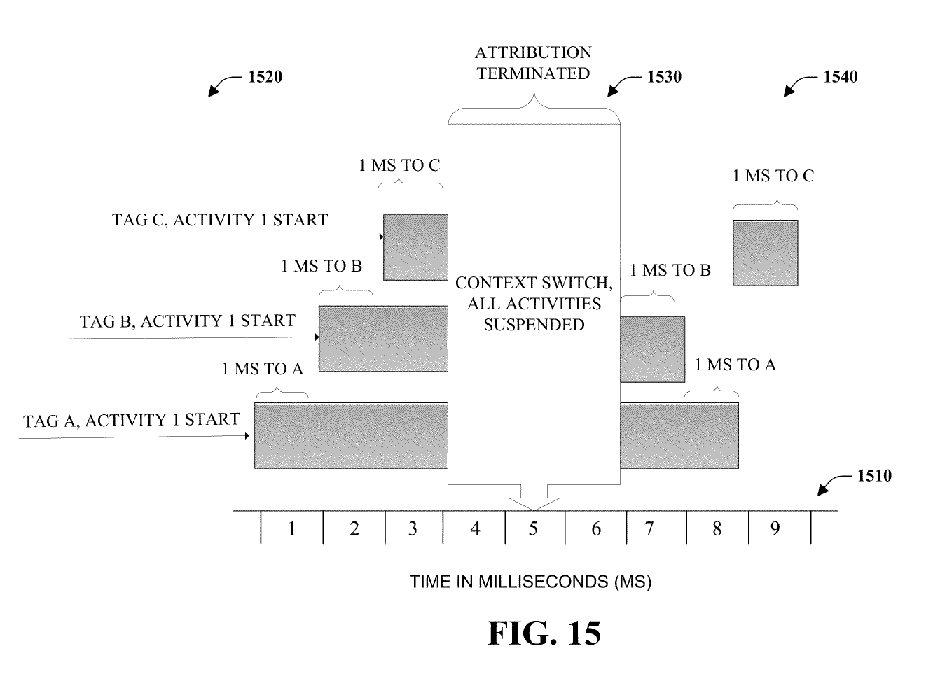

Consider the following organizational scheme authored in XML in conjunction with FIG. 15, in which tags identify groups.

```
<?xml version=“1.0” encoding=“utf-8”?>
<TagSet Name=“ExampleTagSet”>
  <Tag Name=“A”>
    <Events>
      <EventStart Provider=“ExampleProvider”
      Symbol=“A_Activity1_START”/>
      <EventStop Provider=“ExampleProvider”
      Symbol=“A_Activity1_STOP”/>
    </Events>
    <Tag Name=“B”>
      <Events>
        <EventStart Provider=“ExampleProvider”
        Symbol=“B_Activity1_START”/>
        <EventStop Provider=“ExampleProvider”
        Symbol=“B_Activity1_STOP”/>
      </Events>
      <Tag Name=“C”>
        <Events>
          <EventStart Provider=“ExampleProvider”
          Symbol=“C_Activity1_START”/>
          <EventStop Provider=“ExampleProvider”
          Symbol=“C_Activity1_STOP”/>
        </Events>
      </Tag>
    </Tag>
  </Tag>
</TagSet>
```

This organizational scheme concerns an instrumented approach to data collection including a plurality of start/stop event pairs for three arbitrary groups (a.k.a. tags) “A,” “B,” and “C.” FIG. 15 shows an event stream timeline 1510 of nine milliseconds, which is a level of granularity chosen solely for illustrative purposes. In this timeline 1510, an event associated with group/tag “A” starts, as indicated in the organizational scheme as “A_Activity1_START.” During execution and prior to the an exit event associated with tag “A,” an event associated with group/tag “B” fires, noted as “B_Activity1_START.” An event pertaining to group/tag “C” (“C_Activity1_START) occurs at millisecond three while “A” and “B” are in progress, and an exit event (“C_Activity1_STOP”) occurs before millisecond four. At millisecond four, a context switch occurs and this particular line of activity is suspended. As indicated, no execution data will be attributed during milliseconds four, five, and six. At millisecond seven, tag “B” finishes execution, and at millisecond eight, tag “A” finishes. At millisecond nine, a start/stop pair for tag “C” occurs. Because neither tag “A” nor tag “B” is in progress, this time unit is added to tag “C.” Accordingly, there is time 1520 before the context switch, time 1530 during the context switch and time 1540 after the context switch. During time 1520, one millisecond is attributed to each of group/tag “A,” “B,” and “C.” During time 1530, no time is attributed to any group. During time 1540, one millisecond is attributed to each of group/tag “A,” “B,” and “C.”

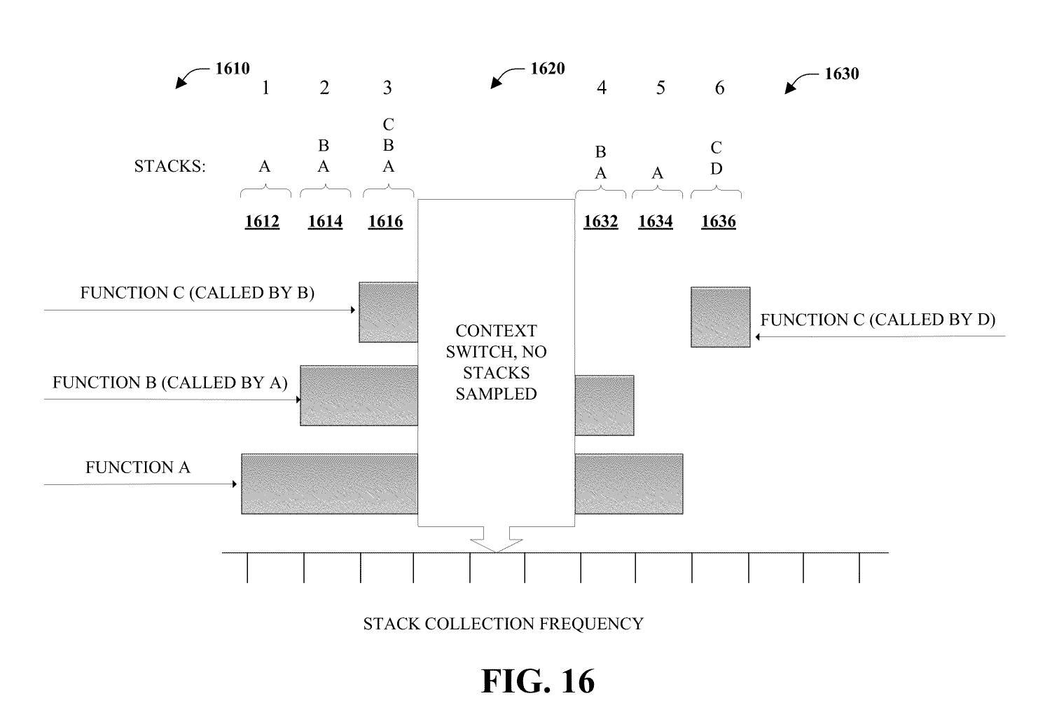

The following is a similar scenario except that sampling is the data collection mechanism rather than instrumentation. Consider the following organizational scheme specified in XML in conjunction with FIG. 16, in which tags identify groups and the structure defines hierarchical relationships between groups.

```
<?xml version=“1.0” encoding=“utf-8”?>
<TagSet Name=“ExampleTagSet”>
  <Tag Name=“A”>
      <Entrypoint Module=“BinaryOne.dll” Method=“ClassOne::A”/>
    <Tag Name=“B”>
        <Entrypoint Module=“BinaryOne.dll” Method=“ClassOne::B”/>
      <Tag Name=“C”>
        <Entrypoint Module=“BinaryTwo.dll”
        Method=“HelperClass::C”/>
      </Tag>
    </Tag>
  </Tag>
</TagSet>
```

Here, the organizational scheme is defined for groupings of stack samples. As shown in FIG. 16, six stacks are collected three during time 1610 before a context switch, zero during time 1620 corresponding to the context switch, and three during time 1630 after the context switch. In the first sample 1612, solely function “A” is executing. In the second sample 1614, function “B” has been called by function “A” resulting of a stack of “A” and “B” (A::B). As defined by the organizational scheme, time associated with this code stack is attributable to “B.” In the third sample 1616, function “C” has been called by function “B” which was called by function “A” resulting in a stack of “A,” “B,” and “C.” In accordance with the organizational scheme, time for this code stack is attributed to “C.” There are no samples collected during time 520 due to the context switch. In the fourth sample 1632, solely functions “A” and “B” remain in execution resulting in a stack of “A” and “B” (A::B), and time is attributed to “B.” In the fifth sample 1634, the code stack includes solely function “A” consequently resulting in time being attributed to “A.” Next, in sample six 1636, function “C” is called by function “D” resulting in a stack of “D” and “C” (D::C). In this case, “C” is the closest frame associated with a defined group and it is therefore added to group/tag “C.” Note that neither “A” nor “B” is required to be on the stack in order to provide this bucketing as might be assumed strictly on the basis of examining the hierarchical XML.

FIG. 16 is also helpful for clarifying the role of priority in the system. Imagine that group “C” has been given a lower priority than “A” or “B” (countermanding an implied priority established by the fact that children are, in the absence of any other explicit mark, higher in priority than parents). In this scenario, the third collected stack “A::B::C” would actually be attributed to group “B,” as the highest priority group in the analyzed stack. The sixth collected stack “D::C” would still be ascribed to group “C,” as described above.

Note also that an organizational scheme, such as the previous organizational scheme, can employ wild cards and/or pattern matching with respect to symbol/event names. Consider, for example, use of a star wildcard character as in “module=‘*’ method=‘malloc’”. Here, an allocation routine will be called across all modules. As another example consider “method=‘ClassOne::*’”. In this case, all members of “ClassOne” are identified.

Returning to FIG. 3, additional details are provided about how instrumentation and sampling can be employed with respect to grouping. The instrumentation approach utilizes a number of event start/stop pairs to demarcate a meaningful boundary and separate profile data. In this scenario, an event is a signal that an executing program has hit a specific point in code. Here, there is a pair of events associated with start and stop. For example, a start event can indicate that page rendering has begun and a stop event can indicate that the page rendering has terminated. Further, suppose there is an arbitrary group “A” that is to include data associated with event “B” and event “C.” When event “B” and event “C” start and stop, intervening execution time can be aggregated and ascribed to group “A.” The intervals specified with start stop pairs can thus be coalesced into a logical group “A.” In other words, a number of events can be utilized to demarcate boundaries for groupings. Further, note that events can be associated with non-time-to-execute profile data including bytes or object allocated, page refreshes, registry reads/writes, and threads spawned, among other things. Accordingly, an event can indicate that “X” bytes were allocated, for example.

As per sampling approach, rather than having event start/stop pairs, a sampled stack and timestamp are employed. Groups can be defined with respect to one or more particular stacks. In other words, a subset of stacks is mapped to one or more logical groups. In the instrumentation approach, it is known when an event such as “C” fires. However, there is also a stack corresponding event “C” firing. Additionally, event “C” may be fired from multiple places, so there can many different stacks that can be attributed to group “A.” For example, it can be indicated that stack “A::B::C” and stack “X::Y::C” are indicative of event “C” and maps to group “A” but stack “D::E::C” does not. In other words, empiric code conditions are detected that indicate that event “C” might have fired and as such associated profile data should be ascribed to logical group “A.” With instrumentation, it is possible to determine precisely what is happening in a program, whereas sampling is an approximation. Sampling essentially indicates that a certain percentage of the time when the program was checked profiling data was ascribed to logical group A.

When working with event start/stop pairs, these pairs lead to logical groupings and allow ascription of associated profile data and aggregation of intervening data points without consulting a stack. For example, when an event such as rendering starts, bytes are allocated, and subsequently the rendering event stops, the bytes allocated are ascribed to group “A,” for example. There is no need to consult a stack. However, if event start/stop pairs are not employed, there can be a stack associated with bytes allocated. In this case, it can be determined or inferred that the bytes allocated are attributable to group “A.” Therefore, stacks in combination with additional data allow a system to work back to the same event start/stop pair grouping. In another scenario, where solely sample stacks are employed time to execute sampling can be employed. Here, the information able to be revealed is the approximate time spent executing in a logical group or the like. In other words, the samples themselves are logically grouped.

It is to be appreciated that grouping information need not be limited to that which is expressed in an organizational scheme to organize profile data. By way of example, consider a data stream that interleaves grouping start/stop event pairs with another event of interest such as bytes allocated. In this case, the grouping start/stop event pairs can be utilized as a basis for grouping the bytes allocated event. In other words, bytes allocated can be ascribed to a group associated with the event start/stop pairs. Of course, stack-grouping information expressed in an organizational scheme can be utilized and applied to a callback associated with an event payload, for instance.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the visualization system 100 can utilize such mechanism to infer visualizations based on historical and contextual information.

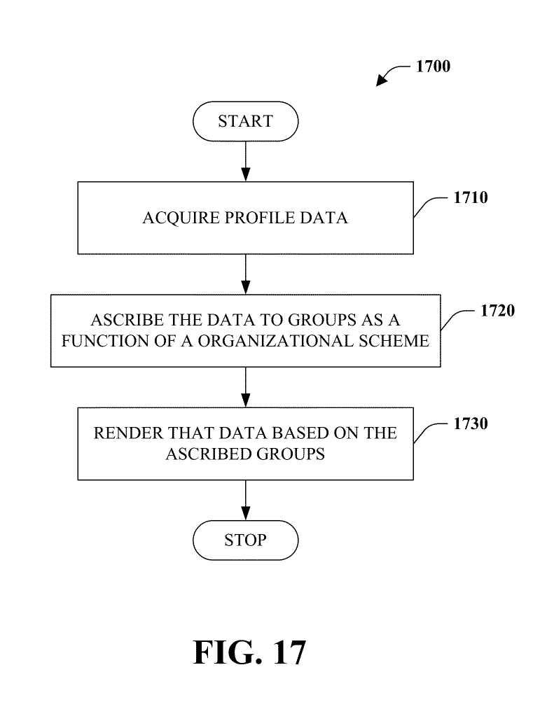

In view of the exemplary systems described supra, methodologies that may be implemented in accordance with the disclosed subject matter will be better appreciated with reference to the flow charts of FIGS. 17-19. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 17, a method of program profiling 1700 is illustrated. At reference numeral 1710, profile data can be acquired. In one instance, such data can be acquired by way code instrumentation, sampling, or both. Alternatively, historical profile data can be received, retrieved, or otherwise obtained or acquired from a log or other persisted file, for example. At numeral 1720, profile data can be ascribed to groups as a function of an organizational scheme that defines groups and relationships between groups. In other words, the organizational scheme can be overlaid on the profile data. Further, the groupings can be associated with high-level functions of a program or a sub-system of the program such that a group is an abstraction that is meaningful for program analysis. As an example, execution time and central processor utilization associated with a first set of functions responsible for layout of content in browser window can ascribed to group “A” while the same data associated with a second set of functions that display the browser window can be ascribed to group “B.” Further and in accordance with one embodiment, profile data associated with a context switch is excluded. At reference numeral 1730, data can be rendered based on the ascribed groups to visualize grouped data and aid diagnosing performance issues. In one instance, grouped data can be housed in a data store that can be queried to retrieve requisite data for a visualization. Further, the visualization can be embodied as a graphical user interface that can enable human users to issue or modify queries as well as influence the manner in which data resulting from such queries is presented. Further, alternate organizational schemes may be applied to the data to further aid analysis.

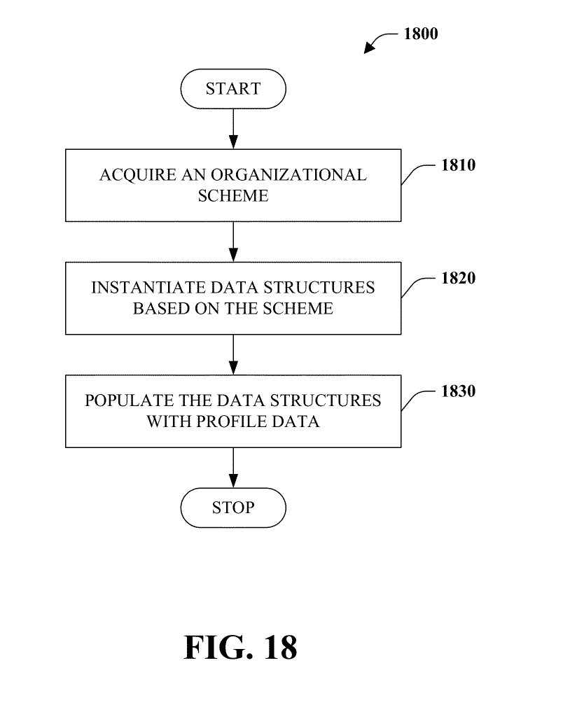

FIG. 18 is a flow chart diagram depicting a method of grouping profile data 1800. At reference numeral 1810, an organizational scheme is received, retrieved, or otherwise obtained or acquired. The organizational scheme can specify groups and relationships between groups. In one instance, the organizational scheme can be manually authored optionally utilizing pattern matching or other filtering mechanisms (e.g., regular expressions, use of wild-card characters . . . ) to aid specification. Additionally or alternatively, the organizational scheme can be generated automatically or semi-automatically based on context or other available information. At numeral 1820, data structures can be created, or instantiated based on the scheme. For instance, structures can be created for each defined group. A reference numeral 1830, the created data structures can be populated with profile data, for instance as it is received. In this manner, profiling data can be ascribed to a group. Subsequently, the grouped data can be queried or saved for later use.

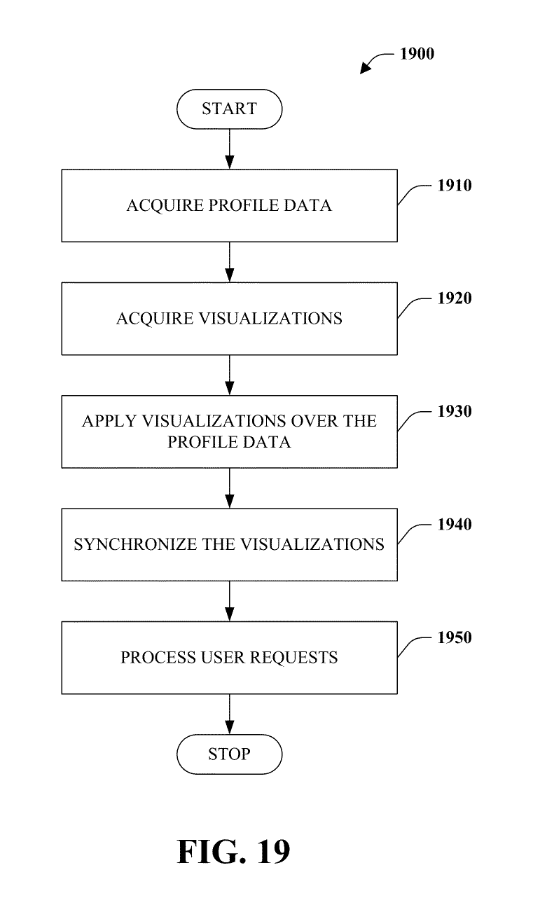

FIG. 19 illustrates a method of visualizing profile data 1900. At reference numeral 1910, profile data is acquired. In one instance, the profile data can be acquired in real time from a currently executing program. Alternatively, the profile data can be acquired from a historical source such as a log file. At numeral 1920, one or more visualizations are acquired by default or in accordance with user selection, for example. At reference 1930, the acquire visualizations are applied over the acquired profile data. At numeral 1940, the visualizations are synchronized to refer to the same segment of data, or, in other words, offer differing views of the same data. For example, timeline-based data can be coordinated as a function of time, and non-timeline-based data can be by scoped to refer to a segment of time displayed by the time-line-based data or a subset set thereof identified by a user. At reference numeral 1950, user requests can be processed over a set of visualizations utilizing a common set of controls. By way of example, if a user selects a particular portion of data of interest utilizing one or the set of visualization as a control, the remaining visualizations of the set can be updated/synchronized. In accordance with one embodiment, profile data can be logically grouped and selection of a subset of information can correspond to navigating a hierarchy of grouped data logically grouped data flows upward from low-level and copious function calls.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component,” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used this description and appended claims in is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

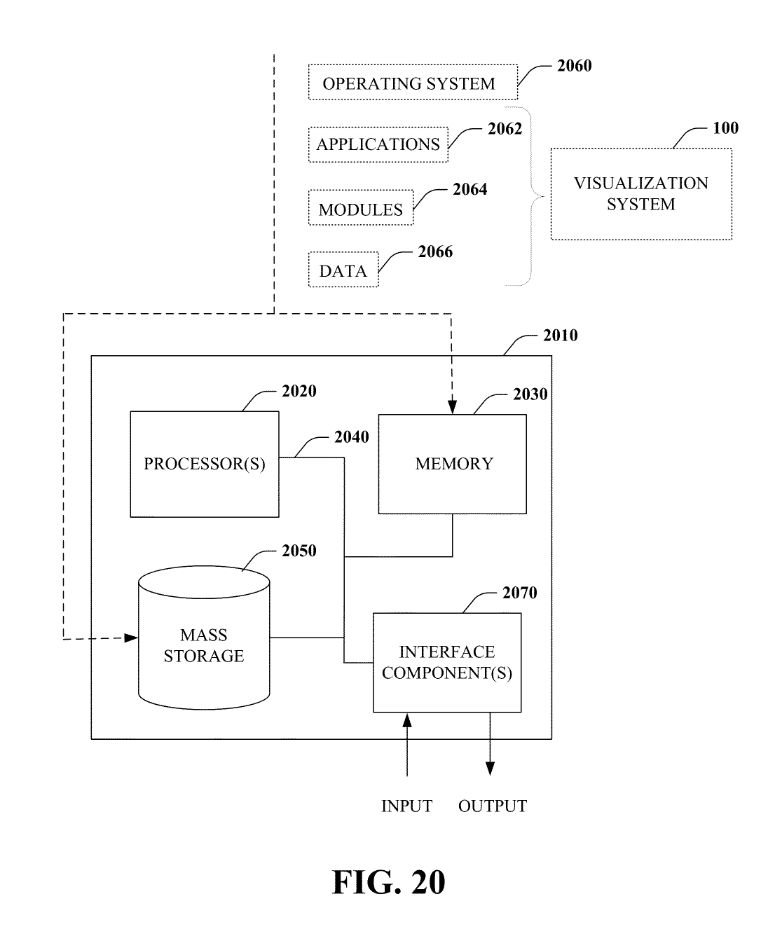

In order to provide a context for the claimed subject matter, FIG. 20 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 20, illustrated is an example general-purpose computer 2010 or computing device (e.g., desktop, laptop, server, hand-held, programmable consumer or industrial electronics, set-top box, game system . . . ). The computer 2010 includes one or more processor(s) 2020, memory 2030, system bus 2040, mass storage 2050, and one or more interface components 2070. The system bus 2040 communicatively couples at least the above system components. However, it is to be appreciated that in its simplest form the computer 2010 can include one or more processors 2020 coupled to memory 2030 that execute various computer executable actions, instructions, and or components stored in memory 2030.

The processor(s) 2020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 2020 may also be implemented as a combination of computing devices, for example a combination of a DSP and a microprocessor, a plurality of microprocessors, multi-core processors, one or more microprocessors in conjunction with a DSP core, or any other such configuration.

The computer 2010 can include or otherwise interact with a variety of computer-readable media to facilitate control of the computer 2010 to implement one or more aspects of the claimed subject matter. The computer-readable media can be any available media that can be accessed by the computer 2010 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 2010.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 2030 and mass storage 2050 are examples of computer-readable storage media. Depending on the exact configuration and type of computing device, memory 2030 may be volatile (e.g., RAM), non-volatile (e.g., ROM, flash memory . . . ) or some combination of the two. By way of example, the basic input/output system (BIOS), including basic routines to transfer information between elements within the computer 2010, such as during start-up, can be stored in nonvolatile memory, while volatile memory can act as external cache memory to facilitate processing by the processor(s) 2020, among other things.

Mass storage 2050 includes removable/non-removable, volatile/non-volatile computer storage media for storage of large amounts of data relative to the memory 2030. For example, mass storage 2050 includes, but is not limited to, one or more devices such as a magnetic or optical disk drive, floppy disk drive, flash memory, solid-state drive, or memory stick.

Memory 2030 and mass storage 2050 can include, or have stored therein, operating system 2060, one or more applications 2062, one or more program modules 2064, and data 2066. The operating system 2060 acts to control and allocate resources of the computer 2010. Applications 2062 include one or both of system and application software and can exploit management of resources by the operating system 2060 through program modules 2064 and data 2066 stored in memory 2030 and/or mass storage 2050 to perform one or more actions. Accordingly, applications 2062 can turn a general-purpose computer 2010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the visualization system 100, or portions thereof, can be, or form part, of an application 2062, and include one or more modules 2064 and data 2066 stored in memory and/or mass storage 2050 whose functionality can be realized when executed by one or more processor(s) 2020.

In accordance with one particular embodiment, the processor(s) 2020 can correspond to a system on a chip (SOC) or like architecture including, or in other words integrating, both hardware and software on a single integrated circuit substrate. Here, the processor(s) 2020 can include one or more processors as well as memory at least similar to processor(s) 2020 and memory 2030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the visualization system 100 and/or associated functionality can be embedded within hardware in a SOC architecture.

The computer 2010 also includes one or more interface components 2070 that are communicatively coupled to the system bus 2040 and facilitate interaction with the computer 2010. By way of example, the interface component 2070 can be a port (e.g., serial, parallel, PCMCIA, USB, FireWire . . . ) or an interface card (e.g., sound, video . . . ) or the like. In one example implementation, the interface component 2070 can be embodied as a user input/output interface to enable a user to enter commands and information into the computer 2010 through one or more input devices (e.g., pointing device such as a mouse, trackball, stylus, touch pad, keyboard, microphone, joystick, game pad, satellite dish, scanner, camera, other computer . . . ). In another example implementation, the interface component 2070 can be embodied as an output peripheral interface to supply output to displays (e.g., CRT, LCD, plasma . . . ), speakers, printers, and/or other computers, among other things. Still further yet, the interface component 2070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

```
APPENDIX A
<?xml version=“1.0” encoding=“utf-8”?>
<TagSet Name=“IE”>
      <ETWNames>
            <Provider Name=“Microsoft-IE” Guid=“123”/>
            <Provider Name=“Microsoft-IEFRAME” Guid=“456”/>
            <Symbol Name=“win:Start” Value=“1”/>
            <Symbol Name=“win:Stop” Value=“2”/>
      </ETWNames>
      <Tag Name=“IEFrame” Graph=“1”>
            <Tag Name=“AsyncWork”>
                  <Entrypoint Module=“ieframe.dll”
            Method=“CAsyncStorage::s_WorkItemCallback”/>
                  <Entrypoint Module=“ieframe.dll”
            Method=“LowFrequencyWorkitemThreadProc”/>
                  <Entrypoint Module=“ieframe.dll”
            Method=“LowFrequencyWorkitemWndProc”/>
                  <Entrypoint Module=“ieframe.dll”
            Method=“QueueLowFrequencyWorkitem”/>
                  <Entrypoint Module=“ieframe.dll”
            Method=“WinList_AsyncWorkitemThreadProc”/>
            </Tag>
            <Tag Name=“NavBar”>
                  <Entrypoint Module=“ieframe.dll”
            Method=“CNavBar::_CreateBar”/>
                  <Entrypoint Module=“ieframe.dll”
            Method=“CNavBar::OnFocusChangeIS”/>
                  <Tag Name=“Address”>
                        <Entrypoint Module=“ieframe.dll”
                  Method=“CAddressBand::s_AddressBandWndProc”/>
                        <Entrypoint Module=“ieframe.dll”
                  Method=“CAddressBand::OnFocusChangeIS”/>
                  </Tag>
            </Tag>
            <Tag Name=“NewTabPage”>
                  <Entrypoint Module=“ieframe.dll”
                  Method=“CShellUIHelper::BuildNewTabPage”/>
                  <Tag Name=“Activities”>
                        <Entrypoint Module=“ieframe.dll”
                        Method=“CNewTabPageActivitiesFactory::
                        BuildActivitiesList”/>
                  </Tag>
                  <Tag Name=“ClosedTabs”>
                        <Entrypoint Module=“ieframe.dll”
                        Method=“CNewTabPageClosedTabsFactory::
                        BuildRecentlyClosedTabsList”/>
                  </Tag>
            </Tag>
            <Tag Name=“StatusBar”>
                  <Entrypoint Module=“ieframe.dll”
                  Method=“CShellBrowser2::s_StatusBarSubclassWndProc”/>
                  <Entrypoint Module=“ieframe.dll”
                  Method=“CDocObjectHost::_ResetStatusBar”/>
            </Tag>
            <Tag Name=“TabManagement”>
                  <Entrypoint Module=“ieframe.dll”
                  Method=“CTabWindowManager::AddBlankTab”/>
                  <Entrypoint Module=“ieframe.dll”
                  Method=“CTabWindowManager::HandleTabBrowserCreated”/>
            </Tag>
            <Tag Name=“Taskbar”>
                  <Entrypoint Module=“ieframe.dll”
                  Method=“CTaskbarBroker::UpdateLiveClipRect”/>
                  <Entrypoint Module=“ieframe.dll”
                  Method=“CTaskbarBroker::OnTabCreated”/>
                  <Entrypoint Module=“ieframe.dll”
                  Method=“CTaskbarBroker::OnTabSelectionChanged”/>
                  <Entrypoint Module=“ieframe.dll”
                  Method=“CTaskbarBroker::OnTabStateChanged”/>
                  <Entrypoint Module=“ieframe.dll”
                  Method=“CTaskbarBroker::CreateInstance”/>
            </Tag>
            <Tag Name=“Thumbnails”>
                  <Entrypoint Module=“ieframe.dll”
                  Method=“CTabThumbnailHandler::v_WndProc”/>
                  <Entrypoint Module=“ieframe.dll”
                  Method=“CTabImageCache::ShouldCatchUpThumbnails”/>
                  <Entrypoint Module=“ieframe.dll”
                  Method=“CTabThumbnailHandler::SetTitle”/>
                  <Entrypoint Module=“ieframe.dll”
                  Method=“CTabThumbnailHandler::CreateInstance”/>
            </Tag>
            <Tag Name=“Networking”>
                  <Entrypoint Module=“ieframe.dll”
                  Method=“FramePreCacheStartup”/>
                  <Entrypoint Module=“ieframe.dll”
                  Method=“StartAutoProxyDetection”/>
                  <Entrypoint Module=“ieframe.dll”
                  Method=“SetProtectedModeFolders”/>
                  <Entrypoint Module=“wininet.dll”
                  Method=“GetUrlCacheEntryInfoW”/>
                  <Entrypoint Module=“ieframe.dll”
                  Method=“CDocObjectHost::_StartAsyncBinding”/>
            </Tag>
            <Tag Name=“NewTabPage”>
                  <Entrypoint Module=“ieframe.dll”
                  Method=“CBrowserFrame::ShowNewTabPage”/>
            </Tag>
            <Tag Name=“PlaySound”>
                  <Entrypoint Module=“ieframe.dll” Method=“SHPlaySound”/>
                  <Module Name=“winmm.dll”/>
                  <Module Name=“wdmaud.drv”/>
            </Tag>
            <Tag Name=“LowFreqWorkerThread”>
                  <Entrypoint Module=“ieframe.dll”
                  Method=“LowFrequencyWorkitemThreadProc”/>
            </Tag>
            <Tag Name=“WSQuery”>
                  <Entrypoint Module=“ieframe.dll”
                  Method=“CWSProvider::Query”/>
                  <Entrypoint Module=“ieframe.dll”
                  Method=“CQueryWorker::ProcessQuery”/>
                  <Entrypoint Module=“ieframe.dll”
                  Method=“CDataModel::Query”/>
                  <Entrypoint Module=“ieframe.dll”
                  Method=“CWSDataItem::GetMatches”/>
            </Tag>
            <Tag Name=“ULV”>
                  <Entrypoint Module=“ieframe.dll”
                  Method=“CUnifiedListViewHost::OnEditContentChanged”/>
                  <Entrypoint Module=“ieframe.dll”
                  Method=“CULVWindow::_LoadDUI”/>
                  <Entrypoint Module=“ieframe.dll”
                  Method=“CULVWindow::UpdateGroup”/>
                  <Entrypoint Module=“ieframe.dll”
                  Method=“CULVWindow::SetCustomUI”/>
            </Tag>
            <Tag Name=“SFToolbar”>
                  <Entrypoint Module=“ieframe.dll”
                  Method=“CSFToolbar::_DefWindowProc”/>
            </Tag>
            <Tag Name=“History”>
                  <ETWStart Provider=“Microsoft-IEFRAME” Id=“0x2c”
                  Version=“0x0” Task=“0x1d” Opcode=“win:Start”
                  Symbol=“ADDTOHISTORY_START”/>
                  <ETWStop Provider=“Microsoft-IEFRAME” Id=“0x2d”
                  Version=“0x0” Task=“0x1d” Opcode=“win:Stop”
                  Symbol=“ADDTOHISTORY_STOP”/>
            </Tag>
      </Tag>
      <Tag Name=“System”>
            <Tag Name=“DPC+ISRs”>
                  <Entrypoint Module=“ntkrnlpa.exe”
                  Method=“KiRetireDpcList”/>
                  <Entrypoint Module=“ntkrnlpa.exe”
                  Method=“KiInterruptDispatch”/>
                  <Entrypoint Module=“ntkrnlpa.exe”
                  Method=“KiIpiServiceRoutine”/>
                  <Entrypoint Module=“halmacpi.dll”
                  Method=“HalpIpiHandler”/>
            </Tag>
            <Tag Name=“ETWStackWalking”>
                  <Entrypoint Module=“ntkrnlpa.exe”
                  Method=“EtwpStackWalkApc”/>
                  <Entrypoint Module=“ntkrnlpa.exe”
                  Method=“EtwpStackTraceDispatcher”/>
            </Tag>
            <Tag Name=“ThreadPool”>
                  <Entrypoint Module=“ntdll.dll”
                  Method=“TppWorkerThread”/>
                  <Entrypoint Module=“ntdll.dll” Method=“TpAllocPool”/>
            </Tag>
            <Tag Name=“ETW>
                  <Entrypoint Module=“ntdll.dll” Method=“EtwEventWrite”/>
            </Tag>
      </Tag>
<Tag Name=“Trident” Graph=“1”><Tag Name=“Script” Graph=“1”>
                  <Entrypoint Module=“mshtml.dll”
                  Method=“CScriptElement::CommitCode”/>
                  <Entrypoint Module=“mshtml.dll”
                  Method=“CScriptElement::Execute”/>
                  <Entrypoint Module=“mshtml.dll”
                  Method=“CWindow::ExecuteTimeoutScript”/>
            </Tag>
<Tag Name=“Layout” Graph=“1”>
                  <ETWStart Provider=“Microsoft-IE” Id=“0x03”
                  Version=“0x0” Task=“0x02” Opcode=“win:Start”
                  Symbol=“MSHTML_CMARKUP_LAYOUT_START”/>
                  <ETWStop Provider=“Microsoft-IE” Id=“0x04”
                  Version=“0x0” Task=“0x02” Opcode=“win:Stop”
                  Symbol=“MSHTML_CMARKUP_LAYOUT_STOP”/>
                  <Entrypoint Module=“mshtml.dll”
                  Method=“CView::EnsureView”/>
            <Entrypoint Module=“mshtml.dll”
            Method=“CDisplay::RecalcView”/>
            <Entrypoint Module=“mshtml.dll”
            Method=“CElement::EnsureRecalcNotify”/>
            <Entrypoint Module=“mshtml.dll”
            Method=“CLayout::DoLayout”/>
            <Entrypoint Module=“mshtml.dll”
            Method=“CRecalcTask::OnRun”/>
            <Tag Name=“BuildBlocks”>
                  <ETWStart Provider=“Microsoft-IE” Id=“0x9f”
                  Version=“0x0” Task=“0x6e” Opcode=“win:Start”
                  Symbol=“MSHTML_CSSLAYOUT_BUILDBLOCKS_START”/>
                  <ETWStop Provider=“Microsoft-IE” Id=“0xa0”
                  Version=“0x0” Task=“0x6e” Opcode=“win:Stop”
                  Symbol=“MSHTML_CSSLAYOUT_BUILDBLOCKS_STOP”/>
                  <Entrypoint Module=“mshtml.dll”
                  Method=“CLayoutBlock::BuildBlock”/>
            </Tag>
            <Tag Name=“BuildLayout”>
                  <ETWStart Provider=“Microsoft-IE” Id=“0xa1”
                  Version=“0x0” Task=“0x6f” Opcode=“win:Start”
                  Symbol=“MSHTML_CSSLAYOUT_BUILDLAYOUT_START”/>
                  <ETWStop Provider=“Microsoft-IE” Id=“0xa2”
                  Version=“0x0” Task=“0x6f” Opcode=“win:Stop”
                  Symbol=“MSHTML_CSSLAYOUT_BUILDLAYOUT_STOP”/>
                  <Entrypoint Module=“mshtml.dll”
                  Method=“Ptls5::FsUpdateBottomlessPage”/>
                  <Entrypoint Module=“mshtml.dll”
                  Method=“Ptls5::FsUpdateBottomlessPageWithHint”/>
                  <Entrypoint Module=“mshtml.dll”
                  Method=“Ptls5::FsUpdateFinitePage”/>
                  <Entrypoint Module=“mshtml.dll”
                  Method=“Ptls5::FsCreatePageFinite”/>
                  <Entrypoint Module=“mshtml.dll”
                  Method=“Ptls5::FsCreatePageBottomless”/>
            </Tag>
            <Tag Name=“BuildDisplay”>
                  <ETWStart Provider=“Microsoft-IE” Id=“0xa3”
                  Version=“0x0” Task=“0x70” Opcode=“win:Start”
                  Symbol=“MSHTML_CSSLAYOUT_BUILDDISPLAY_START”/>
                  <ETWStop Provider=“Microsoft-IE” Id=“0xa4”
                  Version=“0x0” Task=“0x70” Opcode=“win:Stop”
                  Symbol=“MSHTML_CSSLAYOUT_BUILDDISPLAY_STOP”/>
                  <Entrypoint Module=“mshtml.dll”
                  Method=“CPtsPage::SetupDisplayBoxForPage”/>
                  <Entrypoint Module=“mshtml.dll”
                  Method=“CCssPageLayout::SetupDisplayBoxForPage”/>
                  <Entrypoint Module=“mshtml.dll”
                  Method=“CView::CloseDisplayTree”/>
            </Tag>
            <Tag Name=“PTLS” Priority=“−1”>
                  <Namespace Module=“mshtml.dll” Method=“Ptls5::”/>
            </Tag>
      </Tag>
</Tag></TagSet>
```

What is claimed is:

1. A method of visualizing profile data, comprising:
presenting a plurality of correlated visualizations of program profile data on a display of a computing device, the plurality of visualizations provides different types of views of the profile data that are updated as the profile data is acquired.

2. The method of claim 1 further comprises presenting the profile data with one of a set of available visualizations in response to a selection signal indicative thereof.

3. The method of claim 1 further comprises altering appearance of at least one of the plurality of visualizations in response to a selection signal indicative of a sequence of time.

4. The method of claim 1 further comprises visually indicating at least one of failure or satisfaction of one or more conditions with respect one or more of the plurality of visualizations.

5. The method of claim 1 further comprises presenting a set of controls that initiate recording of real time profile data and playback of historical profile data upon selection.

6. The method of claim 5 further comprises initiating recording of at least one of the plurality of visualizations.

7. The method of claim 1 further comprises presenting a textual message correlated with the plurality of visualizations.

8. The method of claim 7 further comprises altering at least one of the plurality of visualizations in response to selection of the text message.

9. The method of claim 1 further comprises presenting an image of an executing program from which the profile data pertains.

10. The method of claim 9 further comprising visually distinguishing at least a portion of the image of the program.

11. A system, comprising:
a processor coupled to a memory, the processor configured to execute the following computer-executable components stored in the memory:
a first component configured to render a set of visualizations of logically grouped program-profile data coordinated as a function of time.

12. The system of claim 11 further comprises a second component configured to record a stream of profile data.

13. The system of claim 12 further comprises a third component configured to facilitate playback of recorded profile data.

14. The system of claim 11, at least one of the set of visualizations indicates failure to meet a performance goal visually.

15. The system of claim 11, the first component is configured to render the set of visualizations during execution of a program from which the profile data is acquired.

16. A computer-readable storage medium having instructions stored thereon that enable at least one processor to perform the following acts upon execution:
rendering a set of one or more visualizations of program profile data grouped based on an organizational scheme that defines groups and relationships between the groups.

17. The computer-readable storage medium of claim 16 further comprises rendering two or more of the set of one or more visualizations coordinated as a function of time.

18. The computer-readable storage medium of claim 16 further comprises receiving one or more selection signals by way of controls shared by the set of one or more visualizations.

19. The computer-readable storage medium of claim 16 rendering a portion of one of the one or more visualizations in a distinct manner to indicate at least one of failure or satisfaction of a performance goal.

20. The computer-readable storage medium of claim 16 further comprises rendering a screenshot of a program under execution from which the profile data is acquired.
